(19) United States
(12) Patent Application Publication
(10) Pub. No.: US 2011/0010265 A1
(43) Pub. Date: Jan. 13, 2011

(54) PRODUCT DESIGN SUBMISSION, SELECTION AND PURCHASE SYSTEM AND METHOD

(75) Inventor: Jimmy Hendricks, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(73) Assignee: Collar Free, Inc., San Diego, CA (US)

(21) Appl. No.: 12/777,230

(22) Filed: May 10, 2010

Related U.S. Application Data
(60) Provisional application No. 61/176,816, filed on May 8, 2009.

(51) Int. Cl. G06Q 30/00; G06F 19/00

(52) U.S. Cl. 705/26.5; 700/97

(57) ABSTRACT

A product design submission, selection and purchase system and method are disclosed. Approved designs of two or more designs for a product received by the computer system via a communications network from at least one designer are displayed in an online gallery. The approved designs are in accordance with design criteria provided to the website by a client. Input to the website is received for the two or more approved designs from website visitor. The two or more approved designs are ranked according to the input to provide ranked designs in an image gallery. A request from at least one customer is received for a for-sale product of one of the ranked designs. The request is then sent to a manufacturer to make the for-sale product for the at least one customer according to the requested one of the ranked designs.

### CROSS REFERENCE TO RELATED APPLICATIONS

This application claims the benefit of priority under 35 U.S.C. §119 to U.S. Provisional Patent Application Ser. No. 61/176,816, filed on May 8, 2009, entitled, “Product Design Submission, Selection And Purchase System And Method”, the entire disclosures of which is incorporated by reference herein.

### BACKGROUND

This disclosure relates generally to system for producing tangible products by accepting designs, aggregating consumer opinions, and leveraging third party on-demand product manufacturing based on a client's product design criteria.

Historically, the method of accepting designs, collecting consumer opinions, and leveraging third party on-demand product manufacturers based on a client's product design criteria was a manual and time consuming process.

Technology has improved much of these processes individually but has not combined all three to increase the efficiency and accuracy of product production based on a product design criteria set by the client.

Conventionally, a client will go through the following process to have a product produced:

1) the client specifies the product design criteria they are looking to achieve. This includes colors, size specifications, a newly manufactured tangible product, or a tangible product modified from another product that exists in the market.

2) the client submits the product design criteria to a designer, a series of designers, or design firms and agencies, which are grouped together by definition hereinafter for brevity as “designers.” The designers then takes the product design criteria and develop a series of possible examples of the product design criteria in an image or pdf format.

3) the designers electronically or physically submit the product design examples back to the client.

4) the client sends these examples electronically or physically to the employees, consultants, or customers of the client's company for review.

5) the employees, consultants, and employees submit their opinions back to the client.

6) the client must decipher the opinions and determine what the most popular products are for production and sale by the client's company.

7) the client manually submits the product designs, that need to be produced, to a third party on-demand product manufacturer.

8) the third party on-demand product manufacturer converts the product designs into visual representations of products that can be purchased by the client or a customer via an online e-commerce store.

9) the third party on-demand product manufacturer sends the website location, url, of the online e-commerce store to the client.

10) the client places the online e-commerce store on their website so their customers can review the products and purchase them.

11) the customers visit a client's website, choose to purchase a product, then are transferred to the online e-commerce store setup by the third party on-demand manufacturer where they can purchase their product by submitting their credit card.

12) the third party on-demand product manufacturer accepts the customer's credit card payment, produces the requested product, packages the product, and ships it to the customer.

The whole process is time consuming, requires excessive manual review, increases personal overhead of a client, and increases the time it takes to manufacturer a product for sale.

### SUMMARY

In general, this document discusses a system and method for producing tangible products by accepting designs, aggregating consumer opinions, and leveraging third party on-demand product manufacturing based on a client's product design criteria.

In one implementation, the system and method are embodied in a software application running on a general purpose processor of a computer platform. In one aspect, a method is disclosed. The method includes displaying, in an online gallery generated for a website hosted by the computer system, approved designs of two or more designs for a product received by the computer system via a communications network from at least one designer, the approved designs being in accordance with design criteria provided to the website by a client. The method further includes receiving input to the website for the two or more approved designs from website visitor, and ranking the two or more approved designs according to the input to provide ranked designs in an image gallery. The method further includes receiving a request from at least one customer for a for-sale product of one of the ranked designs, and sending, by the computer system, the request to a manufacturer to make the for-sale product for the at least one customer according to the requested one of the ranked designs.

The details of one or more implementations are set forth in the accompanying drawings and the description below. Other features and advantages will be apparent from the description, drawings, and the claims.

### BRIEF DESCRIPTION OF THE DRAWINGS

These and other aspects will now be described in detail with reference to the following drawings.

FIG. 1 illustrates a system for producing tangible products by accepting designs, aggregating consumer opinions, and leveraging third party on-demand product manufacturing based on a client's product design criteria.

FIG. 2 is a flowchart of a method for producing tangible products by accepting designs, aggregating consumer opinions, and leveraging third party on-demand product manufacturing based on a client's product design criteria.

FIGS. 3-9 show various user interfaces embodying each step in the flowchart of FIG. 2.

Like reference symbols in the various drawings indicate like elements.

### DETAILED DESCRIPTION

This document describes a system and method to accept product designs from designers based on requested design criteria set by clients who have access to a designated website. The system and method are preferably implemented as a software application running on a client computer in a client/server computing system. Designs that meet the design criteria, which are pre-determined and set by the client, are then entered into a voting component to track votes for a design and rank the designs by the votes entered from anyone who has access to the designated website. A design is also available for purchase through an on-demand component that sends approved designs to a third party on-demand product manufacturer for production. The on-demand component places the design onto a tangible product pre-determined by the client that can be purchased by a customer with a one unit minimum. The on-demand component sends the design after purchase to a manufacturer that produces, packages, and ships the product to the customer that purchases the design.

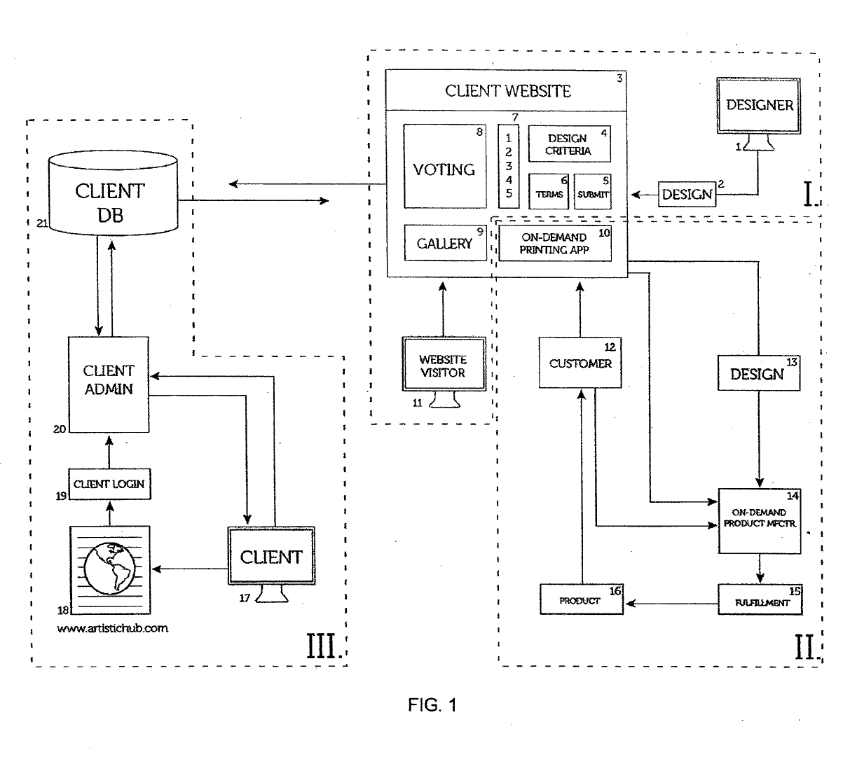

FIG. 1 illustrates a system and method for producing tangible products by accepting designs, aggregating consumer opinions, and leveraging third party on-demand product manufacturing based on a client's product design criteria. Reference characters 1-11 illustrate product design inputs and an application interface for an application embedded in a client's website. An application programming interface (API) allows the application to be embedded in the client's website. The application combines the product design inputs, aggregates user opinions through a voting mechanism, and allows the product design inputs to be sent to a third party on-demand product manufacturer. Reference characters 12-16 illustrate the production of a product by a third party on-demand product manufacturer. The product to be produced is sent by the application based on product design inputs, user opinions, and criteria set by the client. Finally, reference characters 17-21 illustrate a management console that provides an online store, allows a client to manage the application embedded in their site, accept or reject product design inputs, and set criteria to determine which product design inputs are sent to a third party on-demand product manufacturer.

With reference to FIG. 1, a designer 1 designs a product based on criteria 4 displayed on a client website 3. The designer 1 uses their own computer, design software, and submits the design into the application on the client's website 3 using their internet connection from a separate location. The design is submitted into the application via a submission form 5 that allows a designer to upload their design, input the required personal information, and the design is collected and stored in a client database 21.

Design 2 represents a design produced by the designer that is electronically submitted into the application on the client's website transferred over an internet connection from a designer's computer.

Client website 3 includes the application embedded therein. Reference characters 4-10 represent components of the application, and/or the application as a whole. The application combines the product design inputs, aggregates user opinions through a voting mechanism, and allows the product design inputs to be sent to a third party on-demand product manufacturer based on criteria set by the client. Descriptive section 4 within the application displays the product design criteria set by the client and stored in the client database 21, and communicates the product design criteria to the designer 1 so that submitted designs 2 meet the minimum product design criteria set by the client.

A submission form 5 allows the designer 1 to submit designs that, according to certain criteria and/or data, such as opinions, match the product design criteria 4 set by the client. The submission form 5 is accessed through a link that can be selected by the designer 1 via an input device while using a web browser. The form allows a designer to upload their design 2 and enter personal identifier information requested by the client. The design, once uploaded by the designer 1, is sent by the application on the client's website 3 and stored in the client's database 21.

A second descriptive section 6 within the application 3 displays terms and rules set by the client. This section communicates the terms and rules the client expects the designer 1 to accept if they submit their design 2 as a submission 5 to the client. A display 7 ranks the most popular submitted designs 2 based on cumulative votes collected in the client database 21. These votes are preferably collected through voting component 8 that allows a website visitor 11 to rank order, or otherwise qualitatively asses through data input, all of the submitted designs 2 that meet the design criteria 4 set by the client. The votes the website visitor 11 casts are stored in the client database in real time for the client 17 to review.

The voting component 8 of the application on client website 3 allows a website visitor 11 to submit their opinion by voting on designs 2 that meet the design criteria 2 set by the client. The voting component 8 utilizes a voting method set by the client that ranks designs, which is stored in the client database 17. The voting method could be a scale, for example 1 through 5, or it could be a comparison scheme, for example A vs. B, or any other voting method the client chooses. An image gallery 9 displays all designs 2 that have been submitted by any and all designers 1 that meet the design criteria 4 set by the client. Website visitors can search through the image gallery 9 to help determine their opinion on submitted designs 2 before casting their vote 8.

An on-demand printing component 10 sends designs from the design application 3 to a third party on-demand product manufacturer 15. All submitted designs 2 that meet the design criteria 4 set by the client 17 can be purchased by a customer from a third party on-demand product manufacturer 15. A third party on-demand product manufacturer 15 can be any manufacturer that can produce any product design with a minimum order of one. A website visitor 11 visits a client's website 3 and submits their opinion on product designs 2 by using voting component 8.

A website customer 12 can visit a client's website to view submitted designs 2 that meet the design criteria 4 and requests that an individual design be produced by the third party on-demand product manufacturer, and can also purchase the product. The website customer 12 can request that a submitted design 2 be sent to the third party on-demand product manufacturer by moving a submitted design 2 from the image gallery 9 into the on-demand printing component 10. Each submitted design 2 that is in the image gallery 10 can be associated with a link or other user-selectable designating control via an input device that initiates this action while viewing the design through their web browser while accessing the client's website 3. Once the website customer 12 selects this link, the website customer 12 is transferred from the client's website to the website of the third party on-demand product manufacturer 14.

The selected design 13 selected by the website customer 12 after it has been placed into the on-demand printing component 10 is electronically sent to the third party on-demand product manufacturer 14. The selected design 13 may then be displayed on the website of the third party on-demand product manufacturer 14. The website customer 12 is shown the selected design 13 on the third party on-demand product manufacturer's website 14 after they place the design 2 from the gallery 9 into the on-demand printing component 10. The website customer 12 can then enter credit card or other financial transaction data into the website, and confirm a desire to purchase the design on a product from the third party on-demand product manufacturer 14.

A fulfillment 15 of the product 16 from the design 13 purchased by the customer 12 is then tangibly produced. The fulfillment 15 represents the packaging, postage, and shipping of the product from the third party on-demand product manufacturer and delivery to the customer 12. The tangible product 16 that is produced by the third party on-demand product manufacturer 14 is based on the design 13 selected by the customer 12.

A client 17 may be any system or a machine such as a computer that utilizes, executes or runs the design application on a website 3 that it hosts. A company website 18 that the client 17 visits to login and manage the design application can be embedded on the website 3. This allows the company website to be accessed through the client website 3. A secure login 19 can be provided that the client 17 must access through the company website 18 to manage their design application. The login can require security information such as a unique username and password given to the client, or other unique identifiers or access codes.

A client administrative center 20 enables a client 17 to manage the design application 3 embedded on their website. The client 17 can manage and modify the design criteria 4, the descriptive section displaying rules and terms 6, and view the consumer opinions represented by votes from the voting component 8 submitted by website visitors 11. The client 17 can export the votes representing consumer opinions for their own use. The database 21 stores all submitted designs 2 that meet the specified design criteria 4 set by the client 17, the consumer opinion data represented by votes 8 submitted by website visitors 11, and the personally identifying information requested through the submission form 5 by the designer 1.

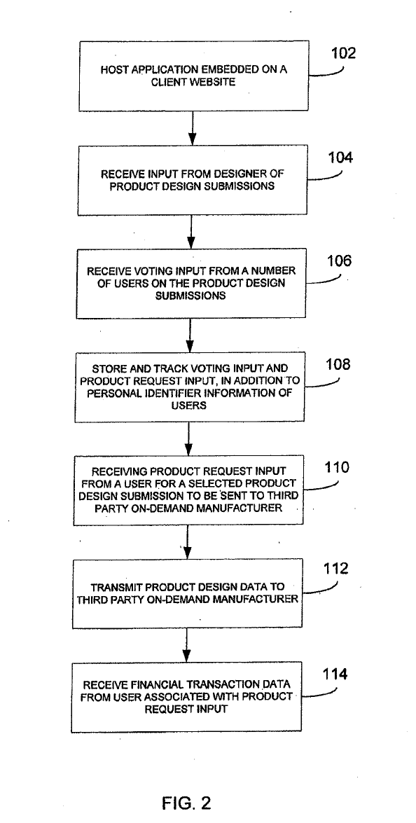

FIG. 2 is a flowchart of a method 100 for producing tangible products by accepting designs, aggregating consumer opinions, and leveraging third party on-demand product manufacturing based on a client's product design criteria. The method 100 can be executed by a computer to: allow a designer to submit product designs based on specified client criteria; allow a client's website visitors to submit their opinions on the product designs through a voting component within the application; and allow a client's website visitor to become a customer by requesting that a product design (i.e. a “for-sale product”) within the application be sent to a third party on-demand product manufacturer. The method 100 can further be executed by the computer to communicate electronically with a third party on-demand product manufacturer to submit a design for production into a tangible product and for that product to be packed, shipped, and delivered to the customer; and to communicate electronically with a secure database that stores submitted designs, designer's personally identifiable information, consumer opinions tracked through voting, and product design criteria set by the client.

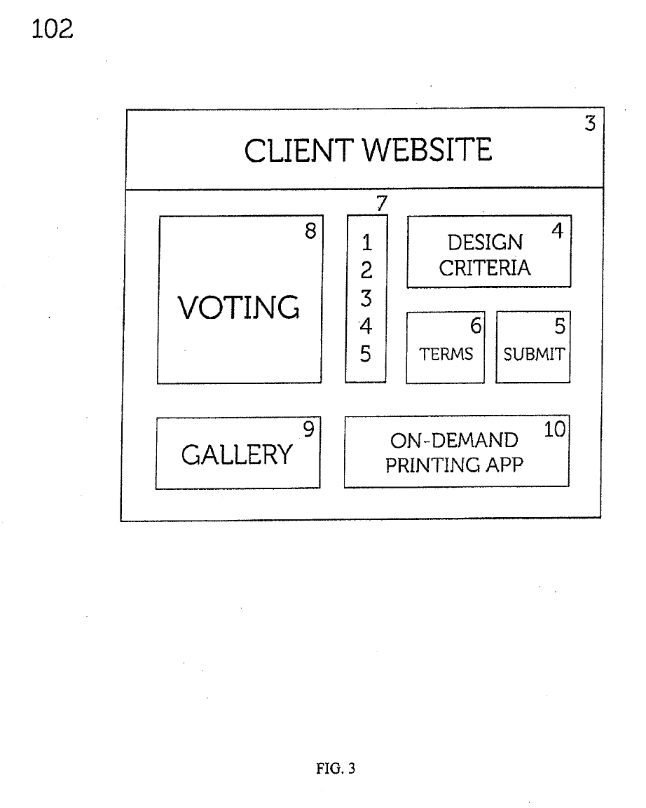

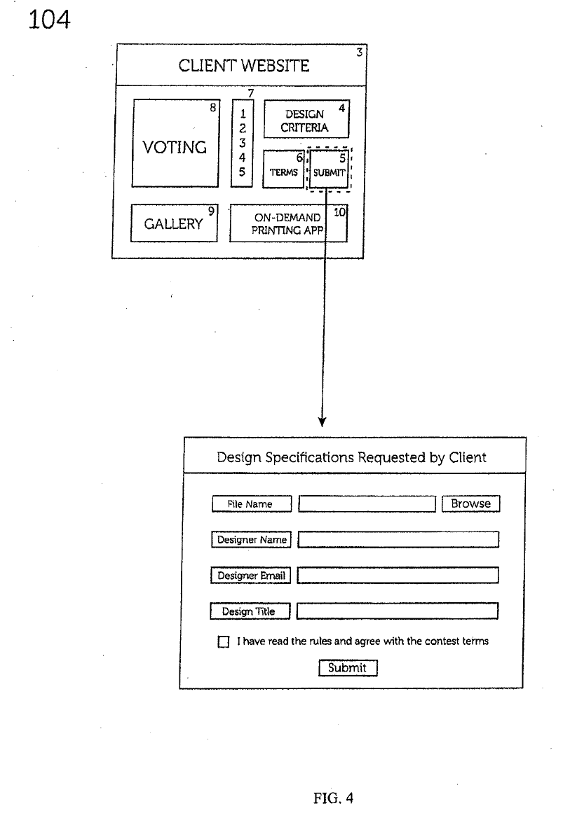

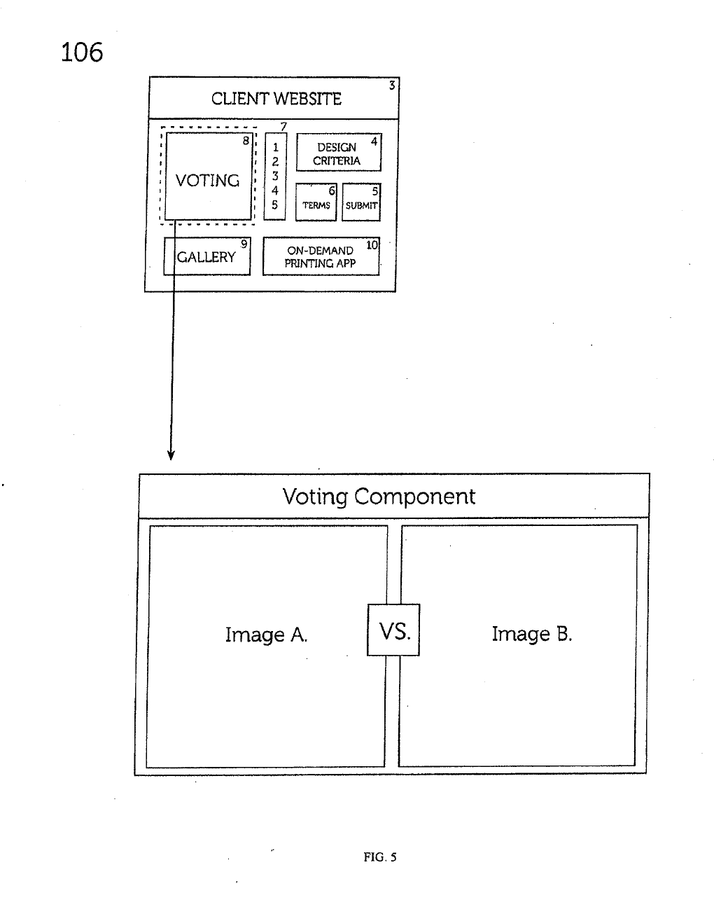

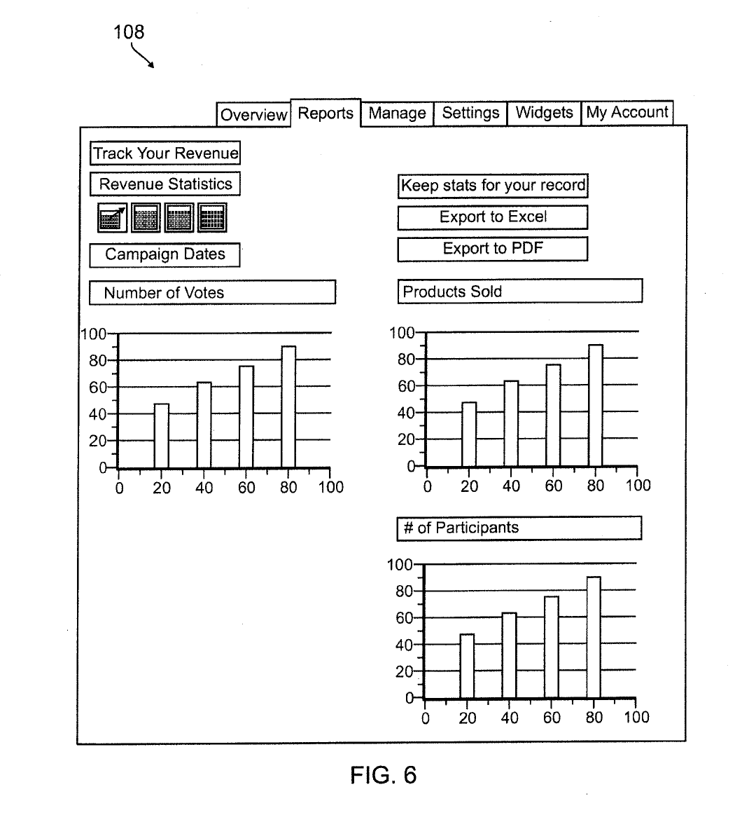

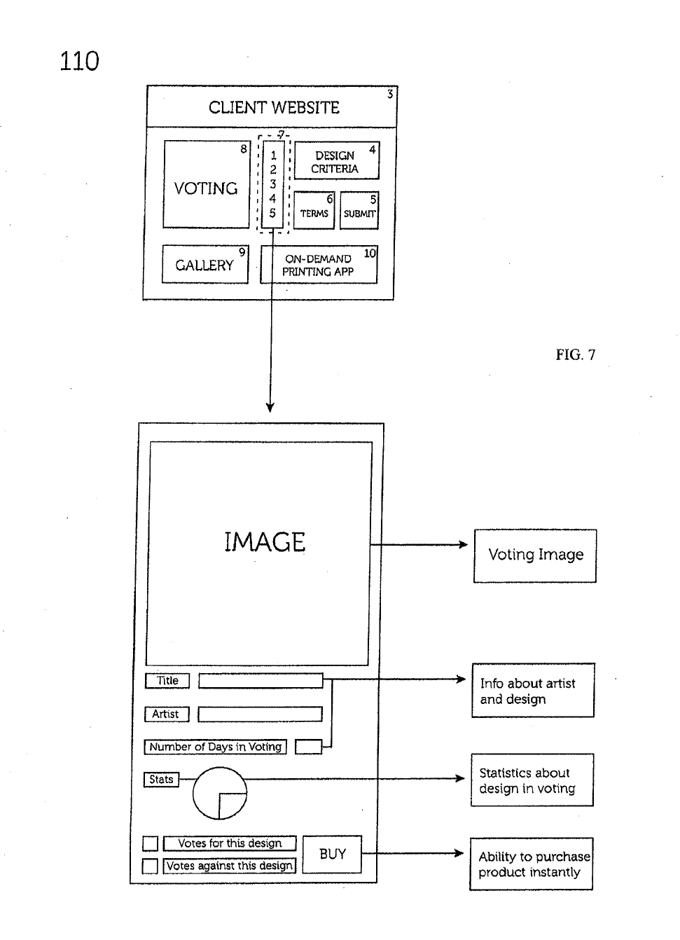

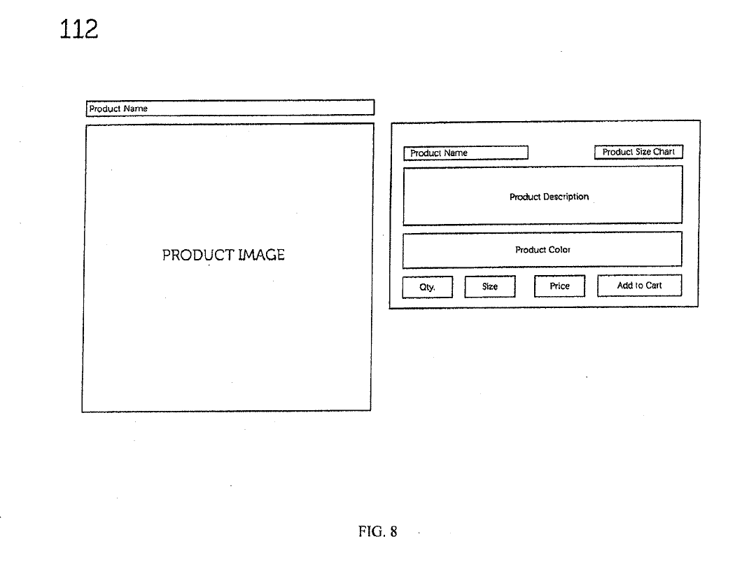

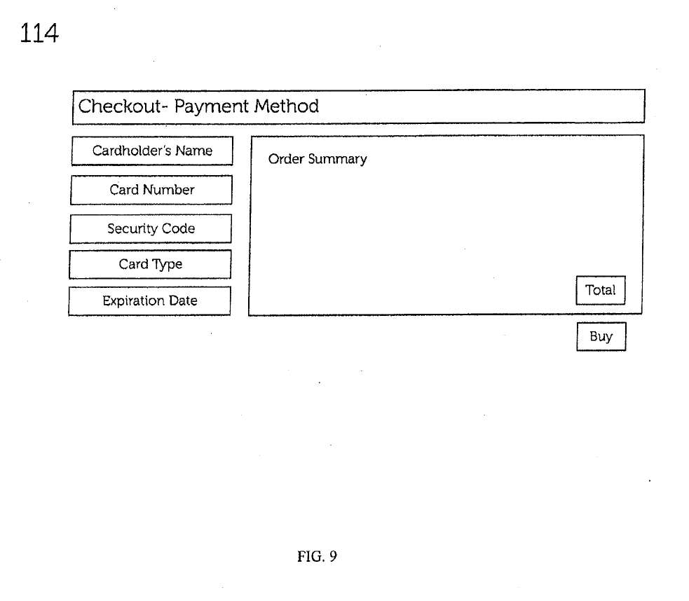

With reference also to FIGS. 3-9, which show various user interfaces embodying each step in the flowchart of FIG. 2, the method 100 begins at 102, in which an application is hosted as embedded in a client website. At 104, input from a designer is received. The input represents one or more product design submissions, and can be in the form of image and/or graphic data. At 106, voting input is received from a number of users. The voting input represents votes, opinions, rankings, or other criteria related to the submitted product designs. At 108, the voting input and product request inputs are stored in a database, along with personal identifier information of the users who inputted the voting input and/or product request input.

At 110, the product request input is received from a user. The product request input represents a request from the user to purchase a product having a selected product design from among the one or more product design submissions, and is electronically sent to a third party on-demand manufacturer. The on-demand manufacturer is preferably embodied as a computer or computer interface that communicates with a product manufacturing capability, such as a factory, warehouse, shipping terminal, etc. At 112, the selected product design represented by the product request input is sent to the on-demand manufacturer, after which the third party on-demand manufacturer is responsible for manufacturing a product with the selected product design, and for shipping the product to the user associated with the product request input. At 114, financial transaction data is received from the user associated with the product request input. The financial transaction data can be credit card or debit card information, bank information, or other financial instrument information for effecting a financial transaction for the user to pay for the requested product. A payment scheme may also be established between the hosted application and the third party on-demand manufacturer.

Some or all of the functional operations and/or components described in this specification can be implemented in digital electronic circuitry, or in computer software, firmware, or hardware, including the structures disclosed in this specification and their structural equivalents, or in combinations of them. Implementations can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate implementations, may also be provided in combination in a single implementation. Conversely, various features which, for brevity, are described in the context of a single implementation, may also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular implementations of the invention have been described. Other implementations are within the scope of the following claims. For example, the steps recited in the claims can be performed in a different order and still achieve desirable results. In addition, implementations of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A method comprising:
receiving one or more designs for a product from at least one designer;
authorizing a client to perform at least one of defining and modifying design criteria for the product;
receiving the design criteria in a computer system;
displaying, in an online gallery generated for a website hosted by the computer system, approved designs of the one or more designs that are in accordance with the design criteria;
receiving input to the website from website visitors;
tracking, by the computer system, the input from the website visitors to rank the selected designs according to a user input scheme;
displaying the designs in the online gallery according to their rank based on the user input scheme;
receiving a request from at least one customer for a requested design of at least one of the approved designs on at least one product; and
if the requested design conforms to a rank threshold for the user input scheme, sending, by the computer system, the request to a manufacturer to make the product for the at least one customer according to the requested design.

2. The method in accordance with claim 1, further comprising receiving, by the computer system, financial data from the at least one customer for a sales transaction to sell the product made according to the requested design to the at least one customer.

3. The method in accordance with claim 1, wherein the input from the website visitors includes votes for at least one of the approved designs.

4. The method in accordance with claim 3, wherein the user input scheme includes a popular vote ranking.

5. The method in accordance with claim 1, wherein displaying approved designs further includes displaying a first approved design and a second approved design together in a window of the online gallery to enable website visitors to vote between the first or second approved design.

6. The method in accordance with claim 5, wherein the user input scheme includes a comparative vote between each pair of the first and second approved designs displayed together in the window of the online gallery.

7. The method in accordance with claim 1, wherein the product includes a shirt.

8. A computer-implemented method comprising:
displaying, in an online gallery generated for a website hosted by the computer system, approved designs of two or more designs for a product received by the computer system via a communications network from at least one designer, the approved designs being in accordance with design criteria provided to the website by a client;
receiving input to the website for the two or more approved designs from website visitor;
ranking the two or more approved designs according to the input to provide ranked designs in an image gallery; and
receiving a request from at least one customer for a for-sale product of one of the ranked designs; and
sending, by the computer system, the request to a manufacturer to make the for-sale product for the at least one customer according to the requested one of the ranked designs.

9. The method in accordance with claim 8, further comprising receiving, by the computer system, financial data from the at least one customer for a sales transaction to sell the for-sale product to the at least one customer.

10. The method in accordance with claim 9, wherein the sales transaction is executed by the computer system.

11. The method in accordance with claim 9, wherein the sales transaction is facilitated by the computer system and executed by the manufacturer.

12. The method in accordance with claim 8, wherein the input from the website visitors includes a votes for at least one of the approved designs.

13. The method in accordance with claim 12, wherein the ranked designs are ranked according to a number of votes received for each approved design.

14. The method in accordance with claim 8, wherein displaying approved designs further includes displaying a first approved design and a second approved design together in a window of the online gallery to enable website visitors to vote between the first or second approved design.

15. The method in accordance with claim 14, wherein the user input scheme includes a comparative vote between each pair of the first and second approved designs displayed together in the window of the online gallery.

16. A system comprising:
a computer system hosting a website and connected with at least one designer and one or more website visitors via a communications network;
an online gallery generated by the computer system that displays approved designs of two or more designs for a product received by the computer system via a communications network from at least one designer, the approved designs being in accordance with design criteria provided to the website by a client;
a ranking module hosted by the computer system that receives input to the website for the two or more approved designs from website visitor, and ranks the two or more approved designs according to the input to provide ranked designs in an image gallery; and
an online store hosted by the computer system that receives a request from at least one customer for a for-sale product of one of the ranked designs, and sends the request to a manufacturer to make the for-sale product for the at least one customer according to the requested one of the ranked designs.
